(19) United States
(12) Patent Application Publication
(10) Pub. No.: US 2023/0256985 A1
(43) Pub. Date: Aug. 17, 2023

(54) METHOD AND SYSTEM FOR AVOIDING VEHICLE UNDERCARRIAGE COLLISIONS

(71) Applicant: Continental Advanced Lidar Solutions US, LLC, Carpinteria, CA (US)

(72) Inventors: Joseph Burtch, Lake Orion, MI (US); Nizar Ahamed, Farmington Hills, MI (US); Peter Lamprecht, Shelby Township, MI (US)

(73) Assignee: Continental Advanced Lidar Solutions US, LLC, Carpinteria, CA (US)

(21) Appl. No.: 17/650,886

(22) Filed: Feb. 14, 2022

(51) Int. Cl. B60W 50/14; B60K 35/00; B60R 1/24; B60R 1/26; B60R 11/04; H04W 4/40; G06V 20/58

(52) U.S. Cl. CPC B60W 50/14; B60K 35/00; B60R 1/24; B60R 1/26; B60R 11/04; H04W 4/40; G06V 20/58; B60W 2050/146; B60W 2420/42; B60W 2556/50; B60K 2370/166; B60K 2370/191; B60K 2370/589; B60R 2011/004

(57) ABSTRACT

A method for avoiding a vehicle undercarriage collision includes identifying an object within a field of view of a vehicle with at least one sensor. a size of the object is determined by comparing the size of the object to a predetermined height of the undercarriage of the vehicle. An indication is provided if the object will collide with an undercarriage of the vehicle

### BACKGROUND

The present disclosure relates to a system and method for avoiding objects that could collide with an undercarriage of a vehicle.

Vehicles include a greater number of autonomous features, such as features that are able to provide driving control with less driver intervention. For example, parking sensors can detect an object, such as a car or a pole, and apply the brakes on the vehicle to prevent a collision and costly repairs to the vehicle.

### SUMMARY

In one exemplary embodiment, a method for avoiding a vehicle undercarriage collision includes identifying an object within a field of view of a vehicle with at least one sensor. a size of the object is determined by comparing the size of the object to a predetermined height of the undercarriage of the vehicle. An indication is provided if the object will collide with an undercarriage of the vehicle.

In another embodiment according to any of the previous embodiments, the indication occurs on a display in the vehicle.

In another embodiment according to any of the previous embodiments, the indication provided on the display of the vehicle includes highlighting the object on an image of a roadway ahead of the vehicle.

In another embodiment according to any of the previous embodiments, the indication suggests a vehicle path to maneuver the vehicle to avoid the object.

In another embodiment according to any of the previous embodiments, the indication provided on the display of the vehicle includes highlighting the object on an image of a roadway with a surround view of the vehicle.

In another embodiment according to any of the previous embodiments, the indication suggests a vehicle path to maneuver the vehicle to avoid the object.

In another embodiment according to any of the previous embodiments, an image of the object is transmitted over a vehicle to everything (V2X) communication system.

In another embodiment according to any of the previous embodiments, an image of the object is transmitted over a vehicle to vehicle (V2V) communication system.

In another embodiment according to any of the previous embodiments, the at least one sensor is an optical camera.

In another embodiment according to any of the previous embodiments, the at least one sensor includes at least one of a radar sensor, an ultrasonic sensor, or a lidar sensor.

In another exemplary embodiment, a rear-view sensor system includes at least one sensor. A hardware processor in communication with the at least one sensor. Hardware memory is in communication with the hardware processor. The hardware memory stores instructions that when executed on the hardware processor cause the hardware processor to perform operations. An object within a field of view of a vehicle is identified with at least one sensor. A size of the object is determined by comparing the size of the object to a predetermined height of a vehicle undercarriage. A signal with an indication is provided if the object will collide with the vehicle undercarriage.

In another embodiment according to any of the previous embodiments, the signal is readable by a display on the vehicle.

In another embodiment according to any of the previous embodiments, signal includes highlighting the object on an image of a roadway ahead of the vehicle.

In another embodiment according to any of the previous embodiments, the signal includes a vehicle path to maneuver the vehicle to avoid the object.

In another embodiment according to any of the previous embodiments, the signal includes highlighting the object on an image of a roadway with a surround view of the vehicle.

In another embodiment according to any of the previous embodiments, the signal provides a suggested vehicle path to maneuver the vehicle to avoid the object.

In another embodiment according to any of the previous embodiments, the at least one sensor monitors an area surrounding a front of the vehicle.

In another embodiment according to any of the previous embodiments, the at least one sensor monitors an area surrounding a rear of the vehicle.

In another embodiment according to any of the previous embodiments, the at least one sensor is an optical camera.

In another embodiment according to any of the previous embodiments, the at least one sensor includes at least one of a radar sensor, an ultrasonic sensor, or a lidar sensor.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 schematically illustrates a vehicle on a roadway approaching an object.

FIG. 2 schematically illustrates a display on the vehicle identifying the object of FIG. 1.

FIG. 3 schematically illustrates the display with a top-down surround view of the vehicle of FIG. 1 approaching the object.

FIG. 4 illustrates a method of identifying an object on a roadway.

### DESCRIPTION

Improvements in advanced safety features, such as collision avoidance and lane keep assist, can reduce the chances of damaging a vehicle and improve the operability of it. However, it is possible that objects can be found on the roadway that are not intended to be there, such as debris that falls off of another vehicle traveling on the roadway. While the vehicle is traveling at high speeds it can be difficult to determine if the object is large enough to strike an undercarriage of the vehicle if driven over. This disclosure is directed to reducing collisions with objects that can collide with the undercarriage of the vehicle.

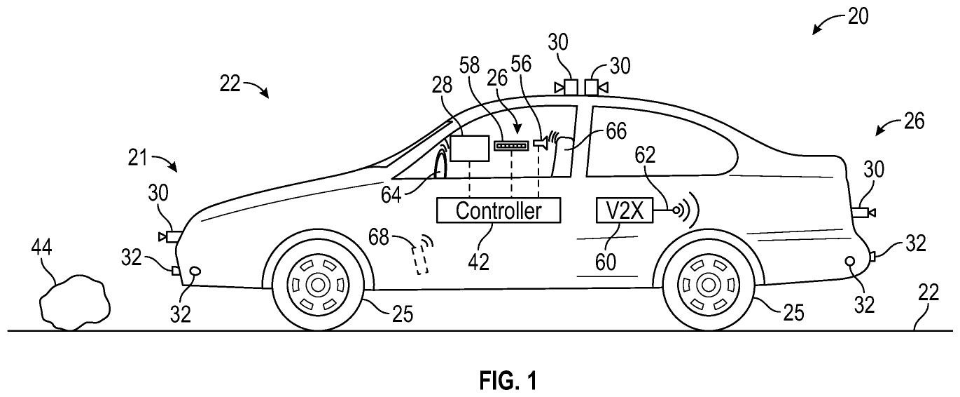

FIG. 1 illustrates an example vehicle 20 traveling on a roadway 22 having an object detection system 40. The vehicle includes a front portion 21, a rear portion 24, and a passenger cabin 26. The passenger cabin 26 encloses vehicle occupants, such as a driver and passengers, and includes a display 28 for providing information to the driver regarding the operation of the vehicle 20.

The vehicle 20 includes multiple sensors, such as optical sensors 30 located on the front and rear portions 21 and 24 as well as a mid-portion of the vehicle 20. In addition to the optical sensors 30, the vehicle 20 can include object detecting sensors 32, such as at least one of a radar sensor, an ultrasonic sensor, or a lidar sensor, on the front and rear portions 21 and 24.

The object detection system 40 includes a controller 42, having a hardware processor and hardware memory in communication with the hardware processor. The hardware memory stores instructions that when executed on the hardware processor cause the hardware processor to perform operations described in the method 100 of avoiding vehicle undercarriage collisions.

The method includes identifying an object 44 within a field of view of the vehicle 20 with at least one of the sensor 30, 32. (Block 110). The object 44 can be a rock, a piece of debris, or etc. In particular, the object sensors 32 can identify the object 44 as the vehicle 20 approaches it through a use of optical images, lidar, and/or radar technologies. In one example, the height of the object 44 is determined with the semantic segmentation combined with directed sparse odometry or quadtree/flame/kimera for 3D environment structure. In another example, structure-from-motion is used to approximate free space. In yet another example, radar scans with elevation data can be used to determine the height of the target objects.

Once the object 44 has been detected by the object detection system 40, the system 40 determines the size of the object 44. (Block 120). In particular, the system 40 determines a height of the object off of the roadway 22 or a width of the object.

Once the object detection system 40 has determined the size of the object 44, the system 40 compares the size of the object 44 to a predetermined size of objects that will clear the undercarriage of the vehicle 20. (Block 130). A determination if the vehicle will clear the object 44 without contact includes comparing at least one of the height or width of the object 44 to a known vertical clearance of the undercarriage and width between the tires 25 traveling on the roadway 22.

Furthermore, the system 40 can predict a trajectory of the vehicle 20 to determine if the there is a possibility of the vehicle traveling over the object 44. The system 40 can utilize at least one of steering angle, rate of speed, or roadway path to determine a predicted trajectory of the vehicle 20.

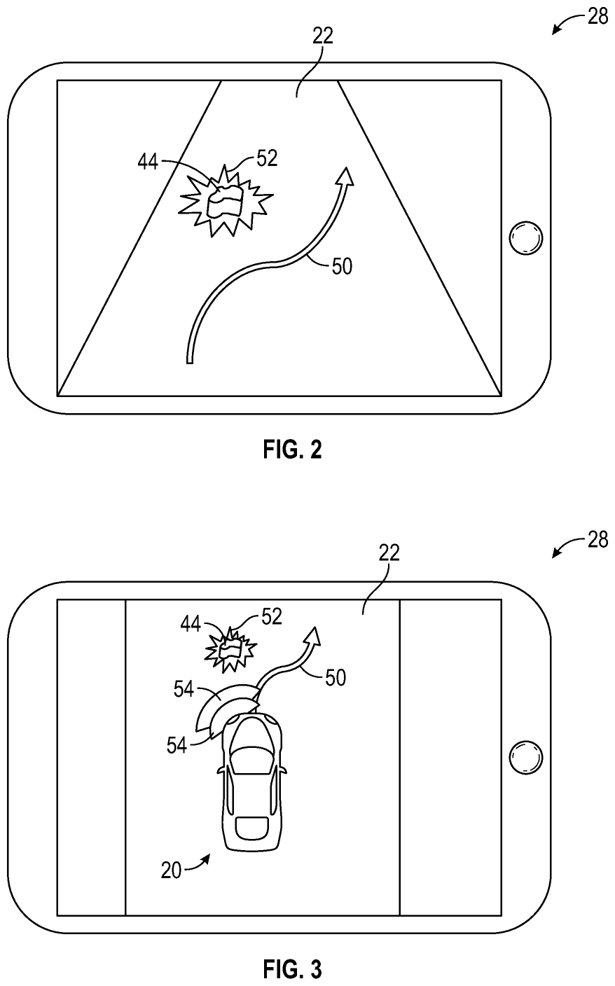

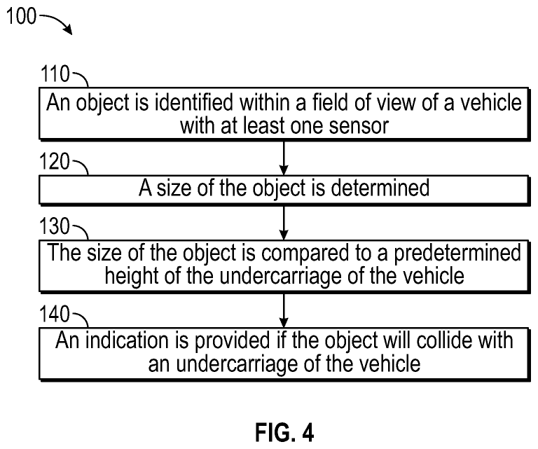

The system 40 can then provide an indication if the object 44 will contact the vehicle 20. (Block 140). The indication can be provided by the controller 42 sending a signal to the display 28 showing a suggested path of travel 50 for the vehicle 20. For example, the path of travel 50 can be superimposed on a front view optical image from the vehicle 20 as shown in FIG. 2, or on a surround view optical image as shown in FIG. 3. The location of the object 44 on the display can be highlighted, such as by jagged lines 52, to allow the operator of the vehicle 20 to quickly identify the location of the object 44 on the display 28. Furthermore, as shown in FIG. 4, the system 40 can predict an area of contact that the object 44 will have with the vehicle 20 with indicia 54. The indicia 54 provide a prediction on the location of impact based on the current predicted trajectory of the vehicle 20.

Therefore, the driver of the vehicle 20 can perform the suggested maneuver 50 to avoid the object 44 or another maneuver that the driver selects based on driving conditions and vehicle speed. For example, the driver may choose to reverse the vehicle 20 if the predicted trajectory 50 is unsatisfactory.

While FIGS. 2 and 3 provide views of the vehicle 20 traveling in a forward direction, the system 40 also operates when the vehicle 20 is operating in reverse to identify objects 44 behind the vehicle 20 and still provide a suggested path of travel 50 in reverse or indicia 54 that would indicate a location of impact.

The system 40 can also provide visual or audible alerts that warn of a potential impact with the object 44. For example, a light array 58 in the passenger cabin 26 could illuminate to predict a likelihood of collision by the number of lights on the array illuminated with the least number of lights indicating the lowest possibility of collision and the greatest number of lights indicating the highest possibility of collision. Similarly, an audible alert on an audible device 56 could be used in addition to the visual alert with the light array 58. Furthermore, haptic vibration feedback can be provided through a steering wheel 64, driver's seat 66, or active-force-feedback-pedal 68.

The system 40 can also communicate with a Vehicle-to-everything (V2X) communication system 60. V2X communication includes the flow of information from a vehicle to any other device, and vice versa. More specifically, V2X is a communication system that includes other types of communication such as, V2I (vehicle-to-infrastructure), V2V (vehicle-to-vehicle), V2P (vehicle-to-pedestrian), V2D (vehicle-to-device), and V2G (vehicle-to-grid). V2X is developed with the vision towards safety, mainly so that the vehicle is aware of its surroundings to help prevent collision of the vehicle with other vehicles or objects. In some implementations, the system 40 communicates with other vehicles 20 via V2X by way of a V2X communication link 62. Through the V2X communication link 62, the system 40 can send images of the object 44 to allow other drives to avoid the area in the roadway 22 with the object 44.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

1. A method for avoiding a vehicle undercarriage collision, the method comprising:
identifying an object within a field of view of a vehicle with at least one sensor;
determining a size of the object;
comparing the size of the object to a predetermined height of the undercarriage of the vehicle; and
providing an indication if the object will collide with an undercarriage of the vehicle.

2. The method of claim 1, wherein providing the indication occurs on a display in the vehicle.

3. The method of claim 2, wherein the indication provided on the display of the vehicle includes highlighting the object on an image of a roadway ahead of the vehicle.

4. The method of claim 2, wherein the indication suggests a vehicle path to maneuver the vehicle to avoid the object.

5. The method of claim 2, wherein the indication provided on the display of the vehicle includes highlighting the object on an image of a roadway with a surround view of the vehicle.

6. The method of claim 5, wherein the indication suggests a vehicle path to maneuver the vehicle to avoid the object.

7. The method of claim 1, further comprising transmitting an image of the object over a vehicle to everything (V2X) communication system.

8. The method of claim 1, further comprising transmitting an image of the object over a vehicle to vehicle (V2V) communication system.

9. The method of claim 1, wherein the at least one sensor is an optical camera.

10. The method of claim 1, wherein the at least one sensor includes at least one of a radar sensor, an ultrasonic sensor, or a lidar sensor.

11. A rear-view sensor system, the system comprising:
At least one sensor;
a hardware processor in communication with the at least one sensor; and
hardware memory in communication with the hardware processor, the hardware memory storing instructions that when executed on the hardware processor cause the hardware processor to perform operations comprising:
identifying an object within a field of view of a vehicle with at least one sensor;
determining a size of the object;
comparing the size of the object to a predetermined height of a vehicle undercarriage; and
providing a signal with an indication if the object will collide with the vehicle undercarriage.

12. The system of claim 11, wherein the signal is readable by a display on the vehicle.

13. The system of claim 12, wherein signal includes highlighting the object on an image of a roadway ahead of the vehicle.

14. The system of claim 12, wherein the signal includes a vehicle path to maneuver the vehicle to avoid the object.

15. The system of claim 12, wherein the signal includes highlighting the object on an image of a roadway with a surround view of the vehicle.

16. The system of claim 15, wherein the signal provides a suggested vehicle path to maneuver the vehicle to avoid the object.

17. The system of claim 11, wherein the at least one sensor monitors an area surrounding a front of the vehicle.

18. The system of claim 11, wherein the at least one sensor monitors an area surrounding a rear of the vehicle.

19. The system of claim 11, wherein the at least one sensor is an optical camera.

20. The system of claim 11, wherein the at least one sensor includes at least one of a radar sensor, an ultrasonic sensor, or a lidar sensor.
